(19) United States
(12) Patent Application Publication
(10) Pub. No.: US 2018/0001568 A1
(43) Pub. Date: Jan. 4, 2018

(54) CALIBRATION OF APPARATUS

(71) Applicant: HEWLETT-PACKARD DEVELOPMENT COMPANY, L.P., Houston, TX (US)

(72) Inventors: Salvador Sanchez Ribes, Sabadell (ES); David Ramirez Muela, Barcelona (ES); Sergio Puigardeu Aramendia, Barcelona (ES); Pol Fornos, Barcelona (ES)

(73) Assignee: HEWLETT-PACKARD DEVELOPMENT COMPANY, L.P., Houston, TX (US)

(21) Appl. No.: 15/542,958

(22) PCT Filed: Jan. 26, 2015
(86) PCT No.: PCT/EP2015/051438

§ 371 Date: Jul. 12, 2017

(51) Int. Cl. B29C 64/393; B33Y 50/02; B33Y 10/00; B33Y 30/00; B29C 64/165; B29C 64/264

(52) U.S. Cl. CPC B29C 64/393; B29C 64/165; B29C 64/264; B33Y 10/00; B33Y 30/00; B33Y 50/02

(57) ABSTRACT

A method of calibrating an apparatus for generating a three-dimensional object is described in which a calibration substrate is generated by depositing build material and applying energy to the build material to form a fused surface; a calibration pattern is generated on the calibration substrate by depositing an agent on the calibration surface according to a predetermined pattern; and an attribute of the calibration pattern is measured.

### BACKGROUND

Additive manufacturing systems that generate three-dimensional objects on a layer-by-layer basis have been proposed as a potentially convenient way to produce three-dimensional objects.

### BRIEF DESCRIPTION OF DRAWINGS

Examples will now be described, by way of non-limiting example, with reference to the accompanying drawings, in which:

FIG. 1 is a flowchart of an example of a method of calibrating an apparatus for generating a three-dimensional object;

FIG. 2 is a simplified schematic of an example of an apparatus for generating a three-dimensional object;

FIG. 3 is a simplified schematic of an example of part of an apparatus for generating a three-dimensional object;

FIG. 4 is a flowchart of an example of a method of calibrating an apparatus for generating a three-dimensional object;

FIG. 5 is a flowchart of an example of a method of generating a calibration pattern; and

FIG. 6 is a flowchart of an example of a method of calibrating an apparatus for generating a three-dimensional object.

### DETAILED DESCRIPTION

Additive manufacturing techniques may generate a three-dimensional object through the solidification of a build material. The build material may be powder-based and the properties of generated objects may depend on the type of build material and the type of solidification mechanism used. In a number of examples of such techniques build material is supplied in a layer-wise manner and the solidification method includes heating the layers of build material to cause melting in selected regions. In other techniques, chemical solidification methods may be used.

Additive manufacturing systems may generate objects based on structural design data. This may involve a designer generating a three-dimensional model of an object to be generated, for example using a computer aided design, CAD, application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

In the examples described herein references to a build material may include, for example, a build material that is a powder-based build material. As used herein, the term powder-based material is intended to encompass both dry and wet powder-based materials, particulate materials, and granular materials.

A process of generating a tangible three-dimension object using an additive manufacturing technique may comprise a series of steps which include forming a layer of build material, selectively delivering an agent, for example a coalescing agent and/or a coalescence modifier agent, to one or more portions of a surface of the layer of build material, and temporarily applying a predetermined level of energy to the layer of build material. The temporary application of energy may cause portions of the build material on which coalescing agent has been delivered or has penetrated to heat up above the melting point of the build material and to coalesce. Upon cooling, the portions which have coalesced become solid and form part of the three-dimensional object being generated. These steps may then be repeated to form a three-dimensional object. Other steps and procedures may also be used with this series of steps.

An agent, for example a coalescing agent or coalescence modifier agent, can be deposited using an agent distributor, which deposits the agent on a build material. In the examples described herein a coalescing agent and coalescence modifier agent can comprise fluids that may be delivered using an agent distributor. In one example the agents are delivered in droplet form.

An agent distributor, according to some examples described herein, may comprise a printhead or printheads, such as thermal printheads or piezoelectric printheads. In one example printheads such as suitable printheads used in commercially available inkjet printers may be used.

The examples described herein are related to a method and apparatus for performing a diagnostic test on or calibrating a build material distributor and/or an agent distributor. The examples may be used in the performance of calibration operations that include, but are not limited to:
alignment of agent distributor(s), e.g. printhead alignment, to compensate printhead position and/or bidirectional compensations in an apparatus which prints in both directions.
agent drop weight (or size) calibration: aging of a printhead or manufacturing differences can affect the drop weight (or size).
nozzle health: verify the status of the nozzles in the printer system, which may be useful to identify a defective nozzle, and to replace the nozzle or printhead if needed, or perform a recovery action.

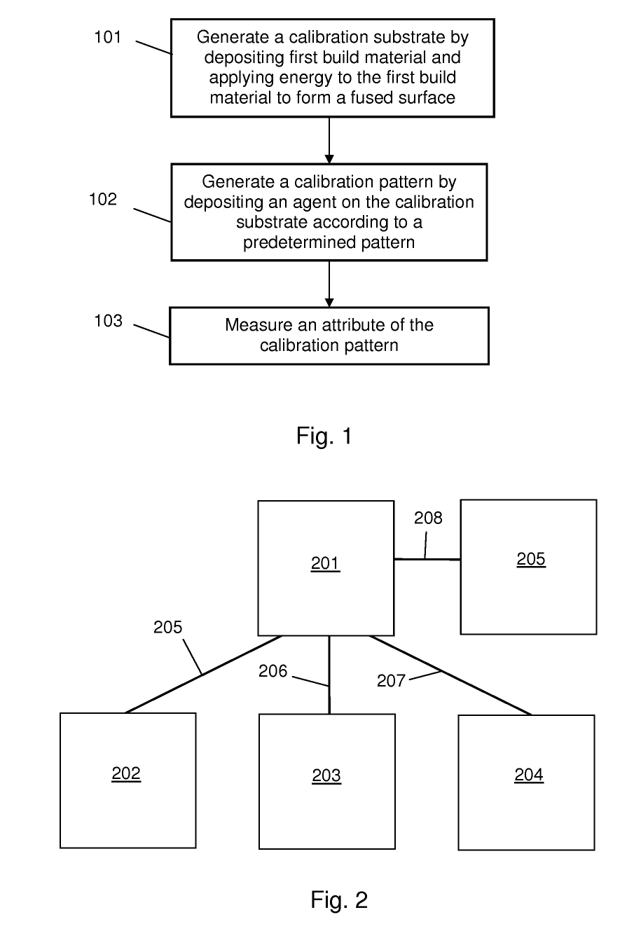

FIG. 1 shows an example of a method of calibrating an apparatus for generating a three-dimensional object. The method comprises generating a calibration substrate by depositing build material and applying energy to the build material to form a fused surface, step 101. In some examples the build material is deposited evenly across a predetermined region. In some examples step 101 comprises depositing multiple layers of build material and applying energy after the deposition of each individual layer. In other words, in such examples the calibration substrate is generated by repeatedly depositing build material and applying energy to the build material, such that the calibration substrate comprises a plurality of layers of build material. In some examples each layer is approximately 0.1 mm thick. In some examples the calibration substrate comprises at least 5 layers of build material. In some examples the number of layers of build material is in the range 5-15. Fewer layers mean that less build material is used, reducing the cost of performing examples of the method, and also that the time to generate the calibration substrate is less. More layers mean that the mechanical stiffness of the calibration substrate is increased, which consequently increases its ease of handling and removal from the apparatus.

In some examples a coalescing agent is applied to the deposited build material before the energy is applied to the build material. The coalescing agent is applied to the whole area of the deposited build material. In some examples in which the generated calibration substrate comprises a plurality of layers of build material, a coalescing agent is applied to each layer of deposited build material before the energy is applied to that layer. These examples enable fusing of the build material to be achieved using a reduced amount of applied energy compared to examples in which no coalescing agent is applied.

In some examples the amount of energy applied to the build material during generation of the calibration substrate is greater than the amount of energy applied to a layer of build material during a normal build operation of the apparatus. Such examples enable fusing of the build material to be achieved without the use of a coalescing agent.

In step 102 a calibration pattern is generated on the calibration substrate by depositing an agent on the calibration surface according to a predetermined pattern. In some examples the agent is a coalescing agent. A coalescing agent causes the fusion of build material onto which it has been deposited when energy is applied to the build material. The level of energy applied may be controlled such that build material with coalescing agent fuses whilst build material without coalescing material does not. A coalescing agent may have a color which determines the color, when fused, of build material to which the coalescing agent has been applied.

In some examples the agent deposited in step 102 is a coalescence modifier agent. A coalescence modifier agent may be used for a variety of purposes. In one example, a coalescence modifier agent may be delivered adjacent to where coalescing agent is delivered, for example to help reduce the effects of coalescence bleed. This may be used, for example, to improve the definition or accuracy of object edges or surfaces, and/or to modify surface roughness. In another example, coalescence modifier agent may be delivered interspersed with coalescing agent, which may be used to enable object properties to be modified. In some examples the agent is a coloring agent, which alters the color of build material on which it is deposited. In some examples the agent is a material-property altering agent, which alters the material properties, e.g. mechanical and physical properties such as strength, hardness, etc., of build material on which it is deposited. In some examples step 102 comprises depositing a plurality of different agents on the calibration substrate in accordance with the predetermined pattern.

In some examples step 102 comprises depositing a first agent, according to a first predetermined pattern, and depositing a second agent, according to a second predetermined pattern. In one example the first agent is a coalescing agent and the second agent is a coalescence modifier agent, and the first and second predetermined patterns are defined such that the coalescence modifier agent is deposited adjacent to the coalescing agent. In some examples the first agent is a coalescing agent having a first color, and the second agent is a coalescing agent having a second color. In some examples the first and second predetermined patterns overlap. In one example a coloring agent is deposited in the same regions as a coalescing agent. In one example a coloring agent is deposited in the same regions as a coalescence modifier agent. In some examples the agent is deposited by an agent deposition system of an apparatus for generating a three-dimensional object.

In some examples the calibration pattern is generated before significant cooling of the apparatus has occurred. This can ensure that the temperature of components of the apparatus, e.g. mechanical components which expand in response to increased temperature, during the generation of the calibration pattern is close to the temperature of these components during the generation of the calibration substrate (the temperature during the generation of the calibration substrate is the normal build mode operating temperature of the apparatus). This in turn can ensure an accurate calibration, since thermal expansion of mechanical parts of the apparatus means that they perform differently at a normal build operating temperature of the apparatus as compared to at a cool temperature.

In some examples the predetermined pattern is designed to enable the replication of some of the existing calibration techniques from 2D printer devices. For example, the predetermined pattern may comprise any of the following 2D calibration patterns:
A line pattern. Line patterns can be measured visually or by a sensor in an apparatus for generating a three-dimensional object to find the straightest line, inside a single color and between colors. An interference pattern. Interference patterns can be measured visually or by a sensor in an apparatus. An interference pattern may comprise, for example a base pattern and an overlay pattern which will be misaligned with respect to each other if a printhead is incorrectly aligned.
A block pattern. Block patterns can be measured by a sensor in an apparatus.
A ramp pattern. Ramp patterns can be measured by a sensor in an apparatus. They are used to align printheads in the direction of the axis of the substrate.
An N pattern. N patterns can be measured by a sensor in an apparatus. They are used to align printheads in the substrate axis direction and can also be used to measure the distance between features in the printer, e.g., between one printhead and the sensor.

In step 103 an attribute of the calibration pattern is measured. In some examples the calibration substrate is left in place within the apparatus during the performance of step 103. In some such examples the measurement is performed by a sensor integrated into the apparatus. In some such examples the measurement is performed by a plurality of sensors integrated into the apparatus. In some examples the calibration substrate is removed from the apparatus before step 103 is performed. In some examples a sensor device separate from the apparatus is used to measure the attribute. In some examples visual inspection by a human operator is used to measure the attribute. In some examples the attribute is a relative location of features of the calibration pattern. In some examples the attribute is the location of an individual drop of an agent, e.g. for use in checking the alignment of an agent distribution system. In some examples the attribute is the darkness or color of an area printed with agent, e.g. for use in checking drop weight and color calibration. In some examples the attribute is the presence of an individual drop of an agent, e.g. for use in checking nozzle health.

The method may be used, for example, in checking the operating parameters and/or performance of an apparatus for generating a three-dimensional object and/or in adjusting an operating parameter of an apparatus for generating a three-dimensional object. In particular examples the method may be used for checking and/or adjusting an operating parameter relating to the deposition of an agent.

Examples described herein have an advantage in that calibration techniques already developed for use with calibrating print systems over a paper/vinyl media support can be used to calibrate three-dimensional print systems that use a non-solid build material, such as powder.

The examples enable the operation of an apparatus for generating a three-dimensional object during a calibration process to correspond closely or exactly to its operation during a normal build process. For example, the distance between the build material distribution system of the apparatus and the substrate onto which build material is being deposited are the same when the apparatus is generating a calibration pattern, as the distance between the build material distribution system and the substrate when the apparatus is generating a three-dimensional object which is not a calibration object. Thus the examples can ensure that the results of the calibration are as accurate as possible.

FIG. 2 shows an example of an apparatus for generating a three-dimensional object, which is suitable to implement the method of FIG. 1. The apparatus comprises a build material deposition system 202 to deposit build material. The apparatus also comprises an energy application system 203, e.g. comprising an energy source, to apply a controlled amount of energy to deposited build material. In some examples the energy source may comprise a lamp, a source of visible light, a source of ultra-violet light, a source of microwave energy, a source of radiation, or a laser source. Other sources of energy or heat may also be used.

The apparatus also comprises an agent deposition system 204, controlled by the processing unit to selectively deposit an agent, e.g. a coalescing agent or a coalescence modifier agent. In some examples the agent deposition system 204 comprises a printhead or printheads, such as thermal printheads or piezoelectric printheads. In one example printheads such as suitable printheads used in commercially available inkjet printers may be used.

The apparatus also comprises a measurement system 205. In some examples the measurement system 205 comprises a height sensor to detect height differences in a surface of an object generated by the apparatus. In some examples the measurement system 205 comprises a color sensor to detect color differences in a surface of an object generated by the apparatus. In some examples the measurement system 205 comprises an optical sensor. In some examples the measurement system comprises a plurality of optical sensors. In one such example the measurement system comprises a set of optical sensors the same as or similar to the optical sensors used in an inkjet printer, e.g. a HP DesignJet inkjet printer.

The apparatus also comprises a processing unit 201 to control the build material deposition system 202, the energy application system 203, the agent deposition system 204 and the measurement system 205. The processing unit 201 is in electronic communication with the build material deposition system 202, the energy application system 203, the agent deposition system 204 and the measurement system 205 by means of communications links 205, 206, 207, 208 which may be wired or wireless. In some examples the processing unit 201, build material deposition system 202, energy application system 203, agent deposition system 204 and measurement system 205 are all provided within a single device housing. In some examples at least one of the processing unit 201, build material deposition system 202, energy application system 203, agent deposition system 204 and measurement system 205 is provided as a separate device.

The processing unit 201 is to control the build material deposition system 202 and the energy application system 203 to generate a calibration substrate by controlling the build material deposition system 202 to deposit build material and by controlling the energy application system 203 to apply energy to the build material to form a fused surface. In some examples the processing unit is to control the build material deposition system 202 and the energy application system 203 to repeatedly deposit build material and then apply energy to it, such that the generated calibration substrate comprises a plurality of layers.

The processing unit 201 is also to control the agent deposition system 204 to generate a calibration pattern on the calibration substrate by depositing an agent on the calibration surface according to a predetermined pattern. In some examples the processing unit is to control the build material deposition system 202, the energy application system 203, and the agent deposition system 204 to generate a calibration pattern on the calibration substrate by depositing further build material on the calibration surface, depositing an agent on the further build material according to a predetermined pattern, and applying energy to the further build material. In some examples the processing unit is to control the build material deposition system 202, the agent deposition system 204 and the energy application system 203 to repeatedly deposit further build material, deposit an agent, and then apply energy, such that the generated calibration pattern comprises a plurality of layers. The further build material is the same as the build material used to generate the calibration substrate.

The processing unit 201 is also to control the measurement system to measure an attribute of the calibration pattern. In some examples the processing unit 201 is to control the measurement system 205 to measure a plurality of attributes of the calibration pattern. In some examples the processing unit 201 is to control the measurement system to recognize specific features, e.g. lines or combinations of lines, in the calibration pattern. In some examples the processing unit is to determine relative locations of features in the calibration pattern. In some examples the processing unit is to compare the measured attribute to the predetermined pattern. In some examples the processing unit is to calculate differences between the measured attributes and the predetermined pattern. In some examples the processing unit is to adjust an operating parameter, for example an alignment of the agent deposition system 204, of the apparatus based on the measured attributes or on a calculated difference between the measured attribute and the predetermined pattern.

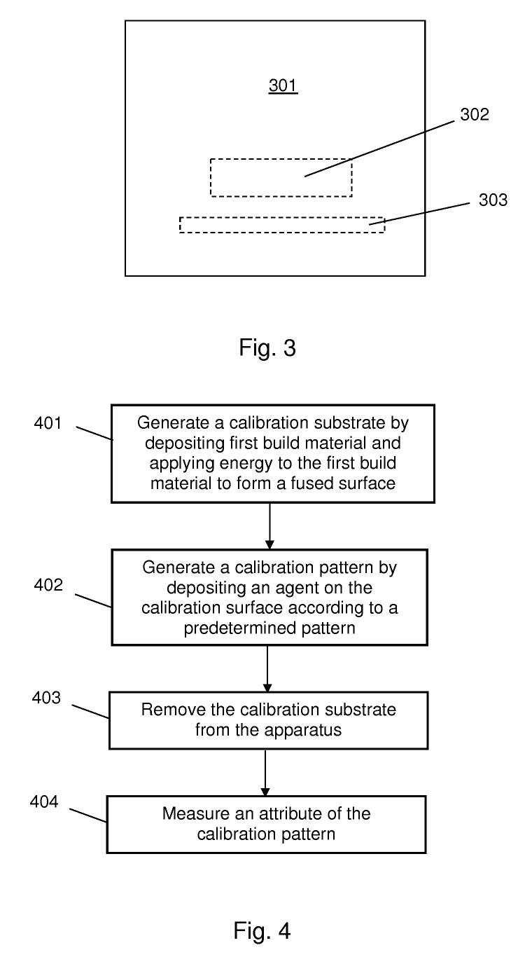

FIG. 3 shows an example of an apparatus 301 for generating a three-dimensional object. The apparatus 301 of FIG. 3 is suitable to implement the method of FIG. 1. The apparatus 301 comprises a build material deposition system 302, an energy application system (not shown), an agent deposition system (not shown), and a measurement system (not shown), which may be the same as the build material deposition system 202, energy application system 203, agent deposition system 204 and measurement system 205 described above in relation to the apparatus shown in FIG. 2.

The example apparatus 301 of FIG. 3 also comprises a heatable support bed 303 onto which an initial layer of build material can be deposited. The support bed is heatable by a heat source disposed in or under the support bed. The apparatus 301 also comprises a processing unit (not shown) to control the deposition system 302, the energy application system, the measurement system, and the heat source. In some examples the processing unit is to control the temperature of the support bed 303 by controlling the operation of the heat source. In some examples the processing unit is to control the heat source to maintain the support bed 303 at a first temperature during a build mode of the apparatus 301 and to maintain the support bed 303 at a second, higher, temperature during a calibration mode of the apparatus 301. In one example the first temperature is below the melting point of a build material and the second temperature is above the melting point of a build material. This ensures that, when a calibration substrate is being generated, it can become completely fused without requiring the application of a coalescing agent.

FIG. 4 shows an example of a method of calibrating an apparatus for generating a three-dimensional object. The method comprises generating a calibration substrate by depositing build material and applying energy to the build material to form a fused surface, step 401. In step 402 a calibration pattern is generated on the calibration substrate by depositing an agent on the calibration surface according to a predetermined pattern. In some examples steps 401 and 402 are performed in the same manner as steps 101 and 102 described above in relation to the example method of FIG. 1.

In step 403 the calibration substrate, with the calibration pattern formed on it, is removed from the apparatus. In some examples step 403 is performed after a certain amount of time has passed since the completion of step 402. This allows the calibration substrate to cool so that it can easily be handled. Depending on the thickness of the calibration substrate, in some cases the calibration substrate may warp as it cools. In some examples the predetermined pattern is designed such that the measured attribute is unaffected by such warping.

In step 404 an attribute of the calibration pattern is measured. In some examples the measurement comprises visual inspection of the calibration substrate by a human operator. In some examples the attribute is measured using a sensor device separate from the apparatus. In some examples step 404 comprises illuminating the calibration pattern with light of different colors, e.g. using LEDs, and measuring the response with an optical sensor. The position of a pattern feature can be determined by determining the minimum (or maximum) of the signal at the sensor. To determine the color of a pattern feature, the value of the signal for light of each color is taken as the measurement. In some examples the measurement is performed using a spectrophotometer.

The example therefore provides the possibility to generate a calibration object that can be evaluated externally. For example, the external evaluation may comprise a visual evaluation, for example whereby values are read and introduced in a form, or input electronically. The example may also enable something to be generated for automatic evaluation, for example involving scanning or optical sensing and post-processing the data to obtain the calibration results. In either of these methods, images and processing techniques may be used, including for example from other printing technologies.

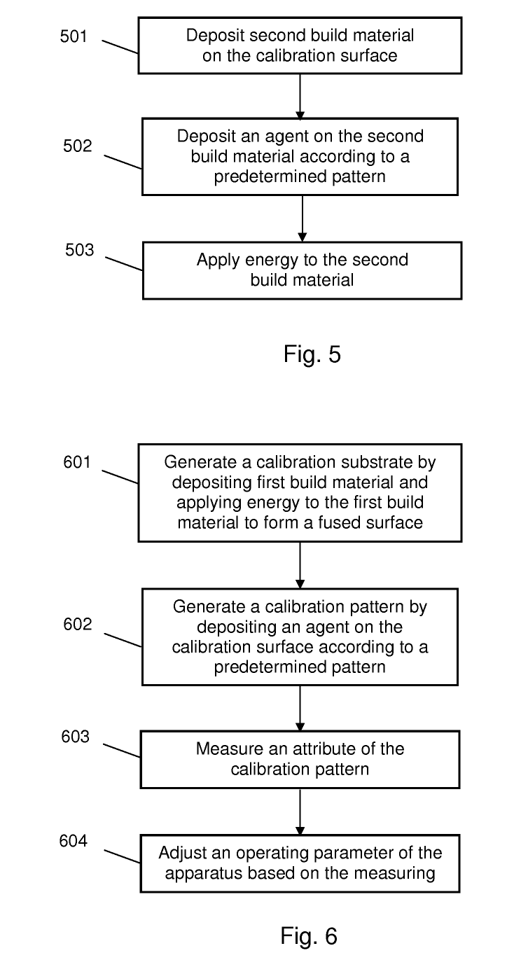

FIG. 5 shows an example of a method for generating a calibration pattern. Further build material is deposited onto the fused surface of a calibration substrate, step 501. In some examples the further build material is deposited evenly across the whole area of the calibration substrate. In some examples the deposition of the further build material is performed in the same manner as the deposition of the build material, as described above in relation to step 101 of FIG. 1. The further build material is the same as the build material deposited in step 101.

In step 502 an agent is deposited on the further build material according to a predetermined pattern. In some examples step 502 is performed in the same manner as step 102 of FIG. 1.

In step 503 energy is applied to the further build material. In some examples the level of the applied energy is selected such that regions of the further build material onto or under which a coalescing agent has been applied are caused to fuse by the application of the energy, whilst regions of the further build material to which no coalescing agent has been applied are not caused to fuse by the application of the energy.

In some examples steps 501, 502 and 503 are performed repeatedly so that the calibration pattern comprises a plurality of layers of build material. Since the predetermined pattern is the same for each layer, this causes the effect of the agent to be amplified, and therefore more easily measureable.

Examples therefore enable aspects of an apparatus for generating a three-dimensional object which relate to the deposition of an agent to be tested and/or adjusted.

FIG. 6 shows an example of a method of calibrating an apparatus for generating a three-dimensional object. The method comprises generating a calibration substrate by depositing build material and applying energy to the build material to form a fused surface, step 601. In step 602 a calibration pattern is generated on the calibration substrate by depositing an agent on the fused surface according to a predetermined pattern. In step 603 an attribute of the calibration pattern is measured. In some examples steps 601, 602 and 603 are performed in the same manner as steps 101, 102 and 103 described above in relation to the example method of FIG. 1. In some examples steps 601, 602 and 603 are performed in the same manner as steps 401-404 described above in relation to the example method of FIG. 4.

In step 604 an operating parameter of the apparatus for generating a three-dimensional object is adjusted based on the measuring performed in step 603. In some examples step 604 comprises altering an alignment of an agent deposition system. In some such examples the alignment is altered by changing the firing timing of a nozzle or group of nozzles so that drops of agent from different printhead/carriage locations are laid down in the same surface location. In some examples the alignment is altered by changing the firing timing of a nozzle or group of nozzles so that drops of agent fired in a left-to-right printing direction and drops of agent fired in a right-to-left printing direction are laid down in the same surface location. In some examples step 604 comprises adjusting a parameter relating to the color and/or darkness of agent laid down by an agent deposition system. In some such examples a parameter relating to color and/or darkness is adjusted by changing the quantity of drops fired at a given surface location. In some examples step 604 is performed automatically in response to a result of step 604 meeting a predefined condition. In one example step 604 is performed automatically in response to the measured attribute deviating by more than a predefined minimum value from the predetermined pattern. In some examples step 604 comprises manually adjusting an operating parameter of the apparatus, e.g. by inputting a new parameter value into a user interface of the apparatus.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operation steps to produce computer-implemented processing, thus the instructions executed on the computer or other programmable devices provide a step for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method of calibrating an apparatus for generating a three-dimensional object, the method comprising:
generating a calibration substrate by depositing build material and applying energy to the build material to form a fused surface;
generating a calibration pattern on the calibration substrate by depositing an agent on the calibration substrate according to a predetermined pattern; and
measuring an attribute of the calibration pattern.

2. A method in accordance with the method of claim 1 wherein the calibration substrate is generated by repeatedly depositing build material and applying energy to the build material, such that the calibration substrate comprises a plurality of layers of build material.

3. A method in accordance with the method of claim 1 wherein generating a calibration pattern on the calibration substrate comprises:
depositing further build material on the calibration substrate;
depositing the agent on the further build material according to the predetermined pattern; and
applying energy to the further build material.

4. A method in accordance with the method of claim 3 wherein the calibration pattern is generated by repeatedly depositing further build material, depositing an agent, and applying energy, such that the calibration pattern comprises a plurality of layers of build material.

5. A method in accordance with the method of claim 3 wherein generating a calibration pattern on the calibration substrate comprises, before applying energy to the further build material, depositing a further agent on the further build material according to a further predetermined pattern.

6. A method in accordance with the method of claim 3 wherein the agent comprises:
a coalescing agent; or
a coalescence modifier agent; or
a coloring agent; or
a material-property altering agent.

7. A method in accordance with the method of claim 1 wherein the calibration substrate is within the apparatus for generating a three-dimensional object during the step of measuring an attribute of the calibration pattern.

8. A method in accordance with the method of claim 1 comprising removing the calibration substrate from the apparatus for generating a three-dimensional object before the step of measuring an attribute of the calibration pattern is performed.

9. A method in accordance with the method of claim 1 wherein the step of measuring an attribute of the calibration pattern comprises determining a relative location of features of the calibration pattern.

10. A method in accordance with the method of claim 1 wherein the apparatus for generating a three-dimensional object comprises a mechanical part which expands in response to a temperature increase, and wherein the temperature of the mechanical part is at least as high during the generation of the calibration pattern as during the generation of the calibration substrate.

11. A method in accordance with the method of claim 1 comprising adjusting an operational parameter of the apparatus for generating a three-dimensional object based on a result of the measuring.

12. An apparatus for generating a three-dimensional object, the apparatus comprising:
a build material deposition system to deposit build material;
an energy application system to apply energy to deposited build material;
an agent deposition system to deposit an agent;
a measurement system; and
a processing unit to:
control the build material deposition system and the energy application system to generate a calibration substrate by depositing first build material and applying energy to the first build material to form a fused surface;
control the agent deposition system to generate a calibration pattern on the calibration substrate by depositing an agent on the calibration substrate according to a predetermined pattern; and
control the measurement system to measure an attribute of the calibration pattern.

13. An apparatus in accordance with the apparatus of claim 12 comprising a heatable bed to receive deposited build material, wherein the processing unit is to control the temperature of the bed to be a first temperature during generation of a calibration substrate, and to be a second, lower, temperature during generation of a three-dimensional object which is not a calibration substrate.

14. An apparatus in accordance with the apparatus of claim 12 wherein the measurement system comprises a height sensor to detect height differences in a surface of an object generated by the apparatus.

15. A non-transitory machine-readable storage medium encoded with instructions executable by a processor, the machine-readable storage medium comprising:
instructions to generate a calibration substrate by depositing build material and applying energy to the build material to form a fused surface;
instructions to generate a calibration pattern on the calibration substrate by depositing an agent on the calibration substrate according to a predetermined pattern; and
instructions to measure an attribute of the calibration pattern.
